(19) United States
(12) Patent Application Publication
(10) Pub. No.: US 2018/0365741 A1
(43) Pub. Date: Dec. 20, 2018

(54) METHOD AND APPARATUS FOR COLLECTING VOC

(71) Applicant: SAMSUNG ELECTRONICS CO., LTD., Suwon-si (KR)

(72) Inventors: Jong-Youb RYU, Suwon-si (KR); Jae-Eun KANG, Suwon-si (KR); Byeong-Hoon KWAK, Uiwang-si (KR); Jae-Hong KIM, Yongin-si (KR); Kyoung-Jin MOON, Suwon-si (KR); Chang-Hyun LEE, Suwon-si (KR)

(73) Assignee: SAMSUNG ELECTRONICS CO., LTD., Suwon-si (KR)

(21) Appl. No.: 15/780,952

(22) PCT Filed: Dec. 7, 2016
(86) PCT No.: PCT/KR2016/014313

§ 371 Date: Jun. 1, 2018

(30) Foreign Application Priority Data
Dec. 7, 2015 (KR) 10-2015-0173160

(51) Int. Cl. G06Q 30/02; H04W 4/021

(52) U.S. Cl. CPC G06Q 30/0282; H04W 4/021; G06Q 30/0281

(57) ABSTRACT

The present disclosure relates to a technology for a sensor network, machine to machine (M2M), machine type communication (MTC), and Internet of things (IoT). The present disclosure may be used for intelligent services (smart home, smart building, smart city, smart car or connected car, healthcare, digital education, retail, security and safety-related service, and the like) on the basis of the technology. The present invention provides a method for collecting voice of customer (VoC) by a server, comprising: receiving information on a user from a user terminal; receiving sensing information related to the user; generating a VoC item for performing a service satisfaction survey for a specific location, on the basis of the information on the user and the sensing information; providing the generated VoC item to the user terminal; and receiving a user response to the VoC item from the user terminal.

### CROSS-REFERENCE TO RELATED APPLICATION

This application is a National Phase Entry of PCT International Application No. PCT/KR2016/014313, which was filed on Dec. 7, 2015, and claims priority to Korean Patent Application No. 10-2015-0173160, which was filed on Dec. 7, 2015, the contents of which are incorporated herein by reference.

### 1. FIELD

The present disclosure relates to a method and an apparatus for collecting Voice of Customer (VoC).

### 2. DESCRIPTION OF RELATED ART

The Internet has evolved from a human-centered connection network, in which humans create and consume information, into an Internet of Things (IoT) network, in which distributed components, such as objects, may exchange and process information. For example, in the Internet of Everything (IoE) technology, big-data processing technology is combined with the IoT through connection with a cloud server and the like.

As technological elements, such as sensing technology, wired/wireless communication and network infrastructure, service interface technology, and security technology, are required to implement IoT, technologies for sensor networks, Machine-To-Machine (M2M) communication, and Machine-Type Communication (MTC) have been studied for connection between objects.

In an IoT environment, an intelligent Internet Technology (IT) service may be provided that collects and analyzes data generated from connected objects to create new value in human life. The IoT is applicable to the fields of a smart home, a smart building, a smart city, a smart car or connected car, a smart grid, health care, a smart home appliance, advanced medical care services, and the like through convergence and integration of existing IT technology with various industries.

Customers are very important resources in business management, and most companies are making various efforts to collect a so-called “Voice of Customer”, i.e. customer feedback, from customers. For example, in a hotel, most hotels collect VoC by conducting a survey on customer-service satisfaction through Guest Comment Cards (GCCs) and by analyzing big data posted on Social Network Services (SNSs), blogs, community sites, or portal sites. The VoC is a major tool for acquiring competitiveness and expanding market dominance by increasing service quality and maximizing marketing effectiveness in a competitive market environment.

A customer survey through GCCs is one of the useful methods for collecting VoC and enables data collection at minimum cost. However, the customer survey through GCCs relies on voluntary customer participation, and very few customers answer the survey. Furthermore, when an actual customer response is not relevant to a service, a management review is required for corrective/preventive actions, which is time-consuming and limits usefulness. In addition, customer surveys through GCCs are generally performed at the time of check-out, so customers provide answers a long time after use/experience related to corresponding items, whereby accuracy and reliability are reduced.

Therefore, it is required to solve the disadvantages and problems of a customer survey through GCCs and to efficiently collect VoC.

### SUMMARY

An embodiment of the present disclosure proposes a method and an apparatus for collecting a Voice of Customer (VoC).

An embodiment of the present disclosure also proposes a method and an apparatus for collecting a VoC based on user's location information or user's moving path information.

In addition, an embodiment of the present disclosure proposes a method and an apparatus for collecting a VoC based on an estimated amount of time period during which a user will stay at a current location and the amount of time period the user has stayed at the current location.

An embodiment of the present disclosure proposes a method for collecting a Voice of Customer (VoC) by a server. The method includes: receiving user information from a user terminal; receiving sensing information related to the user; generating a VoC item for surveying a service satisfaction with a particular location based on the user information and the sensing information; and providing the generated VoC item to the user terminal and receiving a user answer for the VoC item from the user terminal.

Another embodiment of the present disclosure proposes a method for collecting a VoC by a user terminal. The method includes: transmitting user information and sensing information to a server; receiving, from the server, a VoC item for surveying a service satisfaction with a particular location, which is generated based on the user information and the sensing information, and displaying the received VoC item; and transmitting a user answer for the VoC item to the server when the user answer is input.

Still another embodiment of the present disclosure proposes a method for collecting a VoC by a user terminal. The method includes: displaying a VoC item for surveying a service satisfaction with a current location which is measured based on tagging information of the user terminal among VoC items stored through an application of the user terminal; and transmitting a user answer for the VoC item to a server when the user answer is input.

An embodiment of the present disclosure proposes a server for collecting a VoC. The server includes: a communication unit configured to receive information on a user from a user terminal, to receive sensing information related to a location of the user terminal, to transmit a VoC item for surveying a service satisfaction with a particular location to the user terminal, and to receive a user answer for the VoC item from the user terminal; and a controller configured to generate the VoC item based on the user information and the sensing information.

Another embodiment of the present disclosure proposes a user terminal for collecting a VoC. The user terminal includes: a communication unit configured to transmit user information and sensing information to a server, to receive, from the server, a VoC item for surveying a service satisfaction with a particular location, which is generated based on the user information and the sensing information, and to transmit a user answer for the VoC item; and a controller configured to perform control to display the received VoC item.

Still another embodiment of the present disclosure proposes a user terminal for collecting a VoC. The user terminal includes: a controller configured to perform control to display a VoC item for surveying a service satisfaction with a current location which is measured based on tagging information on the user terminal among VoC items stored through an application of the user terminal; and a communication unit configured to transmit a user answer for the VoC item to a server when the user answer is input.

Other aspects, advantages, and key features of the present disclosure will be more apparent to those skilled in the art from the following detailed description that is to be taken in conjunction with the accompanying drawings and illustrates exemplary embodiments of the present disclosure.

According to an embodiment of the present disclosure, it is possible to collect a Voice of Customer (VoC).

Further, according to an embodiment of the present disclosure, it is possible to collect a VoC based on user's location information or user's moving path information.

In addition, according to an embodiment of the present disclosure, it is possible to collect a VoC based on an estimated time that a user will stay at a current location and the time the user has stayed at the current location.

### BRIEF DESCRIPTION OF THE DRAWINGS

The above and other aspects, features, and advantages of exemplary embodiments of the present disclosure will be more apparent from the following detailed description taken in conjunction with the accompanying drawings, in which:

FIG. 1 illustrates a moving path of a customer in each area/facility according to an embodiment of the present disclosure;

FIG. 2 is a flowchart illustrating an example in which a server generates a VoC item in view of the estimated amount of time period that a customer will stay at a current location and the amount of time period that the customer has stayed at the current location according to an embodiment of the present disclosure;

FIG. 3 is a flowchart illustrating an example in which a server generates a VoC item in view of the amount of time period that a customer has stayed at a current location according to an embodiment of the present disclosure;

FIG. 4 illustrates a system that provides a VoC item generated based on information on moving path of a customer according to an embodiment of the present disclosure;

FIG. 5 is a flowchart illustrating an example in which a user answers a VoC item provided from a server by using a user terminal according to an embodiment of the present disclosure;

FIG. 6 is a flowchart illustrating an example in which a server provides a VoC item to a user terminal and receives, from the user terminal, an answer for the VoC item according to an embodiment of the present disclosure;

FIG. 7 illustrates an example of a user interface for a user terminal to generate and display a VoC item according to an embodiment of the present disclosure;

FIG. 8 illustrates another example of a user interface for a user terminal to generate and display a VoC item according to an embodiment of the present disclosure;

FIG. 9 is a flowchart illustrating an example in which a user terminal generates and displays a VoC item according to an embodiment of the present disclosure;

FIG. 10 illustrates the internal configuration of a user terminal that answers a VoC item provided from a server according to an embodiment of the present disclosure; and

FIG. 11 illustrates the internal configuration of a server that provides a VoC item to a user terminal and receives, from the user terminal, an answer for the VoC item according to an embodiment of the present disclosure.

It should be noted that similar reference numerals are used to indicate identical or similar elements, features, and structures through the above figures

### DETAILED DESCRIPTION

Hereinafter, embodiments of the present disclosure will be described in detail with reference to the accompanying drawings.

According to various embodiments of the present disclosure, an electronic device includes a smart phone, a tablet Personal Computer (PC), a mobile phone, a video phone, an electronic book reader (e-book reader), a desktop PC, a laptop PC, a netbook PC, a Personal Digital Assistant (PDA), a Portable Multimedia Player (PMP), a MPEG-1 audio layer-3 (MP3) player, a mobile medical device, a camera, a wearable device (for example, a Head-Mounted Device (HMD), electronic clothing, an electronic bracelet, an electronic necklace, an electronic application (app) accessory(appcessory), an electronic tattoo, and a smart watch), and the like.

Further, according to various embodiments of the present disclosure, the electronic device includes a smart home appliance, for example, a television, a Digital Video Disk (DVD) player, a stereo system, a refrigerator, an air conditioner, a vacuum cleaner, an oven, a microwave oven, a washing machine, a dryer, an air cleaner, a set-top box, a TV box, a game console, an electronic dictionary, a camcorder, a digital photo frame, and the like.

In addition, according to various embodiments of the present disclosure, the electronic device includes a medical device, a navigation device, a Global Positioning System (GPS) receiver, an Event Data Recorder (EDR), a Flight Data Recorder (FDR), an automotive infotainment device, an electronic device for a ship, an avionics device, a security device, a robot for home or industry, and the like.

According to various embodiments of the present disclosure, the electronic device may be a combination of the above-mentioned devices. Further, it will be apparent to those skilled in the art that the terminal according to various embodiments of the present disclosure is not limited to the above-mentioned devices.

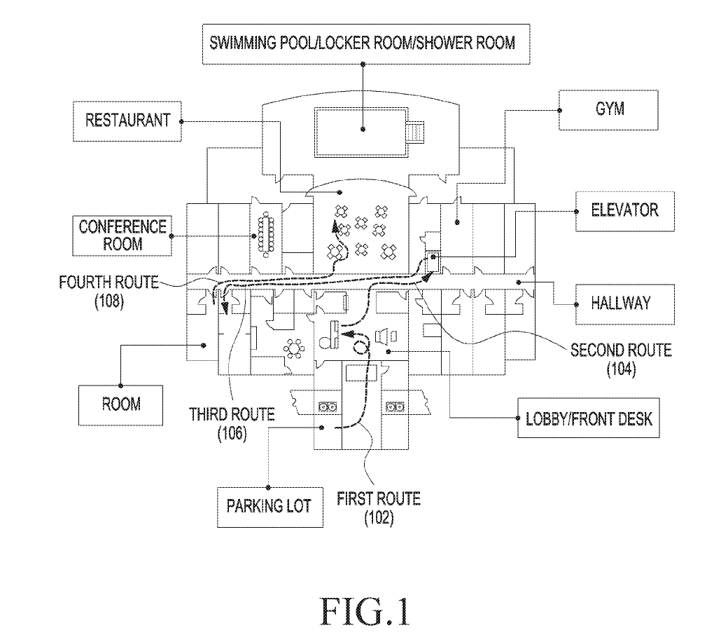

FIG. 1 illustrates a moving path of a customer in each area/facility according to an embodiment of the present disclosure.

FIG. 1 shows an example of transmission and reception for a VoC item and a response signal of the VoC item, between a user terminal and a server according to an embodiment of the present disclosure.

Referring to FIG. 1, a server that generates an item for a service satisfaction survey and provides the item to a customer, is installed inside and/or outside a hotel. Information about a hotel guest such as information on user terminal and information on room of the guest, is registered in the server.

The server detects moving path information by tracing the current location of a customer, generates an item for a service satisfaction survey related to a previous location right before the current location based on the moving path information, and provides the item to the customer. The current location of the customer may generally be measured by room key tagging or indoor positioning using a sensor inside a room key, a sensor of a user terminal, or communication devices. For example, the current location of the customer in a lobby/front desk may be measured using reservation confirmation and check-in information, the current location of the customer in front of an elevator may be measured using information on room key tagging for calling an elevator, the current location of the customer in front of a room may be measured using information on room key tagging for releasing a door lock, and the current location of the customer in front of a restaurant may be measured using information on room key tagging for using the restaurant. Items of a service satisfaction survey are generally provided through a terminal carried by the customer, but may be provided using another terminal installed in a surrounding area/facility, when the customer does not carry the terminal.

Hereinafter, for the convenience of description, an item e service satisfaction survey is referred to as a VoC item.

Assuming that the customer moves from a parking lot to the lobby/front desk along a first moving path 102, the server may detect moving path information by tracing the customer's location information, generates at least one VoC item about the parking lot, which is the previous location, based on the detected moving path information, and provides the VoC item to the customer. The server may generate VoC items for surveying the level of satisfaction with parking facilities, the time period taken to find a parking space, and ease of finding a building entrance after parking, and may provide the VoC items to the customer. Here, the VoC items may be broadly classified into a first-level VoC item and a second-level VoC item according to a depth indicating the length of a question or the concreteness of a question, an answer method indicating whether an answer to a question is a multiple-choice type or a short-answer type, or an answer level indicating whether the number of answer items is great or small if an answer is a multiple-choice type. The first-level VoC item refers to an item including relatively short questions, which pertain to an overall service satisfaction survey on the corresponding location and can be relatively simply answered as an answer method/level includes about two multiple-choice items, such as Yes/No or Satisfied/Dissatisfied. The second-level VoC item refers to an item including long questions, compared to those of the first-level VoC item, which are about specific details or situations on the corresponding location and can be answered in relatively high detail as an answer method/level includes three or more multiple-choice items, such as Very Satisfied/Satisfied/Average/Dissatisfied/Very Dissatisfied, or includes a written-answer type. Such classification of the items is merely an illustrative embodiment of the present disclosure, and does not limit the present disclosure.

The server estimates the amount of time period that the customer will stay at the current location, which is the lobby/front desk, generates a VoC item that can be answered within the estimated time period, and provides the VoC to the customer. That is, the server generates a first-level VoC item “Did you have any problems parking? (Yes/No)” and provides the first-level VoC item to the customer. The VoC item “Did you have any problems parking? (Yes/No)” is generally provided to the customer through a user terminal carried by the customer, for example, a smartphone, a tablet PC, or a wearable device, but may be provided to the customer through a display, device installed at the lobby/front desk or any other device belonging to the hotel when the customer does not have a terminal.

When an answer to the first-level VoC item “Did you have any problems parking? (Yes/No)” is completed within the estimated time period during which the customer will stay at the lobby/front desk, the server may generate a second-level VoC item for a more detailed survey than the first-level VoC item and may provide the second-level VoC item to the customer. Alternatively, when the server provides a plurality of first-level VoC items to the customer and only answers to some VoC items of the plurality of first-level VoC items are completed within the time period that the customer stays at the lobby/front desk, the server may provide the customer with some VoC items that are not answered among the first-level VoC items.

Assuming that the customer moves from the lobby/front desk to the elevator along a second moving path 104, the server may detect moving path information by tracing the customer's location information, generate at least one VoC item about the lobby/front desk, which is the previous location, based on the detected moving path information, and provide the VoC item to the customer. The server may generate VoC items for surveying the impression of/the level of satisfaction with lobby facilities, ease of finding the front desk, and the impression of/the level of satisfaction with the staffs service and may provide the VoC items to the customer.

Further, the server estimates the time period that the customer will stay at the current location, that is, in front of the elevator, generates a VoC item that can be answered within estimated occupancy time period, and provides the VoC to the customer. That is, the server generates a first-level VoC item “Did you wait a long time to check in? (Yes/No)” and provides the first-level VoC item to the customer. The VoC item “Did you wait a long time to check in? (Yes/No)” is generally provided to the customer through a user terminal carried by the customer, but may be provided to the customer through a display device installed in front of the elevator or any other device belonging to the hotel when the customer does not have a terminal.

When an answer to the first-level VoC item “Did you wait a long time to check in? (Yes/No)” is completed within the time period the customer waits in front of the elevator, the server may generate a second-level VoC item for a more detailed survey than the first-level VoC item and may provide the second-level VoC item to the customer. Alternatively, when the server provides a plurality of first-level VoC items to the customer and only answers to some VoC items of the plurality of first-level VoC items are completed within the time period that the customer waits in front of the elevator, the server may provide the customer with some VoC items that are not answered among the first-level VoC items.

Subsequently, assuming that the customer is taking the elevator to the floor where the customer's room is located, the server generates a VoC item for surveying the time period taken for the elevator to arrive after calling the elevator and provides the VoC item to the customer. Here, when the answer for the VoC item is completed within the time period that the customer rides the elevator, the server may provide the customer with a VoC item that has not been surveyed at the previous location, thereby conducting an additional survey.

Assuming that the customer gets off the elevator and moves to the room along a third moving path 106, the server may detect moving path information by tracing the customer's location information, generate at least one VoC item about the elevator, which is the previous location, based on the detected moving path information, and provide the VoC item to the customer. The server may generate VoC items for surveying the level of satisfaction with elevator facilities and may provide the VoC items to the customer.

Further, the server estimates the amount of time period that the customer will stay at the current location, that is, in the room, generates a VoC item that can be answered within the estimated time period, and provides the VoC to the customer. That is, the server generates a first-level VoC item “Did you have any problems using the elevator? (Yes/No)” and provides the first-level VoC item to the customer. When the answer to the first-level VoC item “Did you have any problems using the elevator′? (Yes/No)” is completed within the time period that the customer stays in the room, the server generates a VoC item that has not been surveyed at the previous location and provides the VoC item to the customer. That is, the server generates a second-level VoC item “How satisfied are you with our staffs service? (Very Satisfied/Satisfied/Average/Dissatisfied/Very Dissatisfied)” and provides the second-level VoC item to the customer. The VoC items “Did you have any problems using the elevator? (Yes/No)” and “How satisfied are you with our staffs service? (Very Satisfied/Satisfied/Average/Dissatisfied/Very Dissatisfied)” are generally provided to the customer through a user terminal carried by the customer, but may be provided to the customer through a display device installed in the room or any other device belonging to the hotel when the customer does not have a terminal.

While the customer is staying in the hotel, the third moving path 106 along which the customer gets off the elevator and moves to the room may be repeated a plurality of times. Here, the server may slightly modify the VoC items that have been previously provided and answered and may provide the VoC items to the customer, thereby improving the accuracy of the answer to the same VoC items. That is, the server generates a first-level VoC item “Did it take a long time to use the elevator? (Yes/No)” that can be answered within the estimated time period that the customer will stay in the room and provides the first-level VoC item to the customer. When the answer for the VoC item “Did it take a long time to use the elevator? (Yes/No)” is completed within the time period that the customer stays in the room, the server generates a second-level VoC item “Are the staff friendly and helpful? (Very Satisfied/Satisfied/Average/Dissatisfied/Very Dissatisfied)” and provides the second-level VoC item to the customer.

Here, the VoC it “Are the staff friendly and helpful? Satisfied/Satisfied/Average./Dissatisfied/Very Dissatisfied)” is similar to the previously surveyed VoC item “How satisfied are you with our staffs service? (Very Satisfied/Satisfied/Average/Dissatisfied/Very Dissatisfied)”, and thus the server may notify the customer in advance of the customer's answer to the previously surveyed VoC item and may provide the VoC item “Are the staff friendly and helpful? (Relatively Satisfied/Similar to the Previous Answer/Relatively Dissatisfied)” to be surveyed, thereby surveying a satisfaction level relative to the previous answer.

Assuming that the customer leaves the room and moves to a restaurant along a fourth moving path 108, the server may detect moving path information by tracing the customer's location information, generate at least one VoC item about the room, which is the previous location, based on the detected moving path information, and provide the VoC item to the customer. The server may generate VoC items for surveying the level of satisfaction with room conditions (cleaning and amenities) and may provide the VoC items to the customer.

Further, the server estimates the time period that the customer will stay at the current location, that is, the restaurant, generates a VoC item that can be answered within the estimated time period, and provides the VoC to the customer. In the case of the restaurant, it can be expected that the customer will stay in the restaurant for a long time, compared to other areas/facilities, once going to the restaurant. Therefore, the server may omit a first-level VoC item, may immediately generate a second-level VoC item, and may provide the second-level VoC item to the customer. That is, the server generates a second-level VoC item “Was the bedding organized in a satisfactory manner? (Very Satisfactory/Satisfactory:/Average/Dissatisfactory/Very Dissatisfactory, provides the second-level VoC item to the customer. When an answer to the second-level VoC item “Was the bedding organized in a satisfactory manner? (Very Satisfactory/Satisfactory/Average/Dissatisfactory/Very Dissatisfactory)” is completed within the time period that the customer stays in the restaurant, the server compares the time period that the customer has stayed at the current location with a predetermined time period. When the time period that the customer has stayed at the current location shorter han the predetermined time period, the server continues to generate a VoC item about the previous location, that is, the room, and to provide the VoC item to the customer. However, when the time period that the customer has stayed at the current location is equal to or longer than the predetermined time period, the server generates a VoC item about the current location, that is, the restaurant, and provides the VoC item to the customer. That is, the server generates a second-level VoC item “Were you satisfied with the portion/the taste of the food for the price? (Very Satisfied/Satisfied/Average/Dissatisfied/Very Dissatisfied)” and provides the second-level VoC item to the customer. The VoC items “Was the bedding organized in a satisfactory manner? (Very Satisfactory/Satisfactory/Average/Dissatisfactory/Very Dissatisfactory)” and “Were you satisfied with the portion/the taste of the food for the price? (Very Satisfied/Satisfied/Average/Dissatisfied/Very Dissatisfied)” are generally provided to the customer through a user terminal carried by the customer, but may be provided to the customer through a display device installed on the restaurant table or any other device belonging to the hotel when the customer does not have a terminal.

While the customer is staying in the hotel, the fourth moving path 108 along which the customer leaves the room and moves to the restaurant may be repeated a plurality of times. Here, similar to the case where the third moving path 106 is repeated, the server may slightly modify the VoC items and may provide the VoC items to the customer, thereby improving the accuracy of the answer to the same VoC items. That is, the server generates a second-level VoC item Was the bedding neat and tidy? (Very Satisfied/Satisfied/Average/Dissatisfied/Very Dissatisfied)” that can be answered within the estimated time the customer will stay in the restaurant and provides the second-level VoC item to the customer. When an answer for the VoC item “Was the bedding neat and tidy? (Very Satisfied/Satisfied/Average/Dissatisfied/Very Dissatisfied)” is completed within the time the customer stays in the restaurant, the server compares the time the customer has stayed at the current location with a predetermined time period. When the time the customer has stayed at the current location is shorter than the predetermined time period, the server continues to generate a VoC item about the previous location, that is, the room, and to provide the VoC item to the customer. However, when the time the customer has stayed at the current location is equal to or longer than the predetermined time period, the server generates a VoC item about the current location, that is, the restaurant, and provides the VoC item to the customer. That is, the server generates a second-level VoC item “Were you satisfied with the portion/the taste of the food for the price? (Very Satisfied/Satisfied/Average/Dissatisfied/Very Dissatisfied)” and provides the second-level VoC item to the customer.

Here, the VoC item “Was the bedding neat and tidy? (Very Satisfied/Satisfied/Average/Dissatisfied/Very Dissatisfied)” is similar to the previously surveyed VoC item “Was the bedding organized in a satisfactory manner? (Very Satisfactory/Satisfactory/Average/Dissatisfactory/Very Dissatisfactory)”, and thus the server may notify the customer in advance of the customer's answer to the previously surveyed VoC item and may provide, to the customer, the VoC item “Was the bedding neat and tidy? (Relatively Satisfied/Similar to the Previous Answer/Relatively Dissatisfied)” to be surveyed, thereby surveying a satisfaction level relative to the previous answer.

Also, the VoC item “Were you satisfied with the portion/the taste of the food for the price? (Very Satisfied/Satisfied/Average/Dissatisfied/Very Dissatisfied)” is similar to the previously surveyed VoC item “Were you satisfied with the portion/the taste of the food for the price? (Very Satisfied/Satisfied/Average/Dissatisfied/Very Dissatisfied)” and thus the server may notify the customer in advance of the customer's answer to the previously surveyed VoC item and may provide, to the customer, the VoC item “Were you satisfied with the portion/the taste of the food for the price? (Relatively Satisfied/Similar to the Previous Answer/Relatively Dissatisfied)” to be surveyed, thereby surveying a satisfaction level relative to the previous answer.

The server may estimate whether the customer is currently able to answer the VoC items based on the location information of the customer or moving path change information. In this case, when it is determined that the customer is moving and thus is unable to answer the VoC items, the server may not provide the VoC items to the customer. It is determined whether the customer is currently able to answer the VoC items by measuring the motion of the customer using a sensor (an accelerometer, a gyro sensor, or the like) of a room key and a user terminal, a camera (CCTV), or the like. When the motion is measured using a camera (CCTV), it may be determined whether the customer is currently able to answer the VoC items additionally considering information indicating whether the customer is carrying baggage or remains stationary.

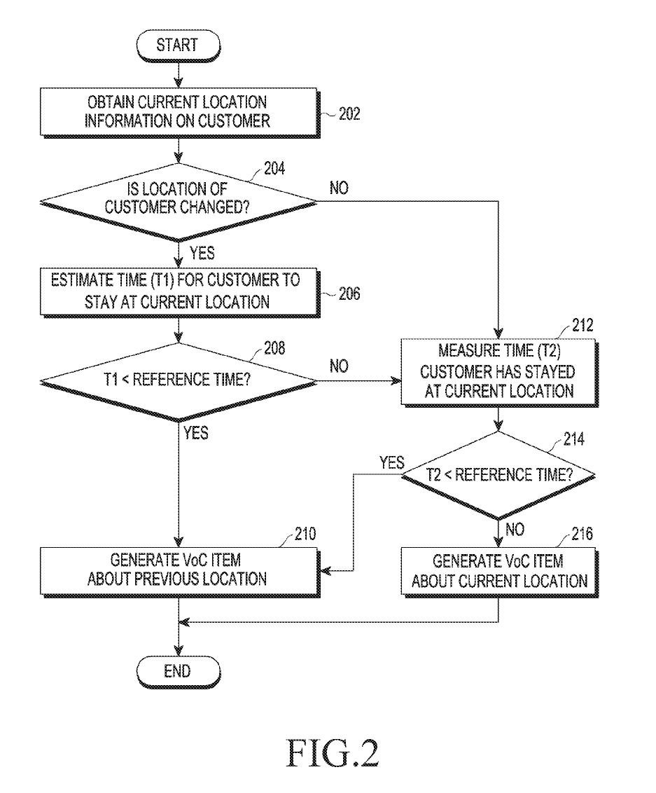

The method in which a server generates at least one VoC item about a previous location based on a customer's moving path information and provides the VoC item to the customer has been described with reference to the first moving path 102 to the third moving path 106, while a method in which a server generates at least one VoC item about a previous location and at least one VoC item about a current location based on a customer's moving path information and provides the VoC items to the customer has been described with reference to the fourth moving path 108. FIG. 2 illustrates a method in detail in which a server generates both a VoC item about a previous location and a VoC item about a current location based on a customer's moving path information and provides the VoC items to the customer.

In FIG. 1, the time period that the customer will stay in each area/facility may be estimated using accumulated statistics from previous customers having used the area/facility and may be estimated based on the actual usage history of the customer. Table 1 shows the statistics of estimated time period according to the intended use of each area/facility and the main actions, and Table 2 shows collected VoC items and the frequency of occupancy/visit according to the change in moving path.

TABLE 1

| Area/facility | Intended use | | Main action | Estimated time |
|---|---|---|---|---|
| Parking lot | Parking | First time | Entering parking lot from outside -> | Within 15 minutes |
| | | | finding parking space -> parking -> | |
| | | | finding building entrance and moving | |
| | | | (carrying pieces of luggage) | |
| | | During stay | Moving from building to parking lot -> | |
| | | | finding parked car -> moving -> leaving | |
| | | | parking lot | |
| | | After | Moving from building to parking lot -> | |
| | | check-out | finding parked car -> moving -> leaving | |
| | | | parking lot | |
| | Others | | Moving from building to parking lot -> | |
| | | | finding parked car -> moving -> taking | |
| | | | care of personal business (taking out | |
| | | | personal items) -> moving to building | |
| | | | entrance | |
| Lobby | Waiting | | Waiting for company, waiting for hotel | Within 10 minutes |
| | | | shuttle to start | |
| Front desk | Check-in | | Entering building from outside -> going | Within 15 minutes |
| | | | to front desk -> confirming reservation | |
| | | | and check-in | |
| Others | | | Calling or going directly to front desk to | |
| | | | make a demand/request | |
| | Check-out | | Moving from room to front desk => | |
| | | | confirming residency status and | |
| | | | check-out | |
| Elevator | Going to | First time | Going to room | Within 5 minutes |
| | another | | | |
| | floor | | | |
| | | During stay | Going to room/facilities (restaurant, | |
| | | | gym, etc.)/lobby, traffic increasing in | |
| | | | particular time (meal time, etc.) | |
| | | After | Using elevator to go to lobby, traffic | |
| | | check-out | increasing in check-out time | |
| Hallway | Moving | -> room | Finding and going to room | Within 3 minutes |
| | | Room -> | Passing to use elevator/facilities | |
| | | | (restaurant, gym, etc.), waiting for | |
| | | | elevator | |
| Room | Stay | | Occupied for longest time during stay | Most time of stay |
| Restaurant | Meal | A la carte | Visit -> taking seat -> sitting -> menu -> | 30 minutes or |
| | | | ordering food -> waiting -> eating -> | longer |
| | | | paying | |
| | | Buffet style | Visit -> taking seat -> sitting -> menu -> | |
| | | | choosing food -> waiting -> eating -> | |
| | | | paying | |

| | | | |
|---|---|---|---|
| Gym | Exercise (fitness, etc.) | Occupied before/during/after exercise | 30 minutes or |
| | | | longer |
| Pool | Exercise (swimming) | | |
| Locker | Changing clothes/taking | | |
| room/shower | shower | | |
| Conference | Meeting | For online/offline meeting | 30 minutes or |
| room | | | longer |

TABLE 2

| Previous | | | Frequency of |
|---|---|---|---|
| area/facility | Current area/facility | Collectable VoC item | occupancy/visit |
| Outside hotel | Parking lot | Satisfaction with | Repeatable |
| | | appearance/surroundings of hotel | |
| | | (Satisfied/Average/Dissatisfied) | |
| | | Satisfaction with location of parking lot | |
| | | entrance (Difficult to find/Average/Easy | |
| | | to find) | |
| Parking lot | In front of elevator | Satisfaction with parking lot facilities | Repeatable |
| | | Survey on time taken to find parking | |
| | | space | |
| | | Ease of finding building entrance after | |
| | | parking | |
| In front of elevator | Elevator | Survey on time taken after calling | Repeatable |
| | | elevator | |
| | | Additional survey on items not surveyed | |
| | | at previous situation | |
| Elevator | Lobby | Satisfaction with elevator facilities | Repeatable |
| Lobby | Front desk | Impression of/satisfaction with lobby | One or two |
| | | facilities | times |
| | | Ease of finding front desk | |
| | | Impression of staff service | |
| Front desk | In front of elevator | Inconvenience/satisfaction during | One or two |
| | | check-in | times |
| | | Evaluation of staff service | |
| | | Survey on waiting time/check-in time | |
| In front of elevator | Elevator | Survey on time taken after calling | Repeatable |
| | | elevator | |
| | | Additional survey on items not surveyed | |
| | | at previous situation | |
| Elevator | Hallway | Satisfaction with elevator facilities | Repeatable |
| Hallway | Room | Inconveniences/satisfaction with hallway | Repeatable |
| | | facilities | |
| | | Overall satisfaction until entering room | |
| Room | Room | Additional survey on items not surveyed | Repeatable |
| | | at previous situation | |
| | | Survey on items related to previous time | |
| | | after entering room | |
| Room | Hallway | Satisfaction with items (MUR, etc.) | Repeatable |
| | | requested in room | |
| Hallway | In front of elevator | Satisfaction with room conditions | Repeatable |
| | | (cleaning and amenities) | |
| In front of elevator | Elevator | Additionally needed requests | Repeatable |
| Elevator | Restaurant | Additional survey on items not surveyed | Repeatable |
| | | at previous situation | |

The estimated time period spent in each area/facility illustrated in Table 1 and the frequency of occupancy/visit illustrated in Table 2 may be used to generate a VoC item. That is, when generating a VoC item, the server may determine different estimated time period even the same area/facility corresponding to an action of the customer and may generate a VoC item in view of the corresponding action and the different estimated occupancy time period for the same location.

FIG. 2 is a flowchart illustrating an example in which a server generates a VoC item in view of the estimated time period that a customer will stay at a current location and the time period that the customer has stayed at the current location according to an embodiment of the present disclosure.

Referring to FIG. 2, in operation 202, the server obtains current location information of the customer. The server is assumed to be a server installed in a particular service area, for example, a hotel, to generate a survey item for a service satisfaction survey and to provide the survey item to a customer, and the current location of the customer may be measured through measurement of indoor position and various positioning method by using room key tagging, a sensor included in a room key, a sensor included in a user terminal, and other communication devices.

In operation 204, the server checks whether the location of the customer is changed. Specifically, in operation 204, when the location of the customer is changed by a certain reference distance or more and then is not changed for a certain time period or longer, the server determines that the location of the customer is changed, which corresponds to the case where the customer moves a certain distance and then does not move for a certain time period. Further, the server may determine that the location of the customer is changed only when the location of the customer is changed by a certain reference distance or more. When it is determined that the location of the customer is changed in operation 204, the server estimates the time period T1 that the customer will stay at the current location, which is the changed location, in operation 206.

In operation 208, the server checks whether the time period T1 that the customer stays at the current location, which is estimated in operation 206, is shorter than a predetermined reference time period for item generation. Here, it is assumed that the reference time period for item generation is, for example, three minutes. When the time period T1 that the customer stays at the current location is shorter than three minutes in operation 208, the server generates a VoC item about the previous location, which is the location before the change, in operation 210.

However, when the time period T1 the customer stays at the current location is equal to or longer than three minutes in operation 208, the server measures the time period T2 that the customer has stayed at the current location in operation 212. In operation 214, the server checks whether the time period T2 the customer has stayed at the current location, which is measured in operation 212, is shorter than the predetermined reference time period for item generation, that is, three minutes. When the time period T2 the customer has stayed at the current location is shorter than three minutes in operation 214, the server generates the VoC item about the previous location, which is the location before the change, in operation 210. However, when the time period T2 the customer has stayed at the current location is equal to or longer than three minutes in operation 214, the server generates a VoC item about the current location in operation 216.

When it is determined that the location of the customer is not changed in operation 204, the server measures the time period T2 that the customer has stayed at the current location in operation 212 and generates a VoC item about the previous location or the current location depending on whether the time period T2 the customer has stayed at the current location is shorter than three minutes or is equal to or longer than three minutes.

Describing operations 210 and 216 with reference to the third moving path 106 of FIG. 1, when the time period T1 the customer stays at the current location, that is, the restaurant, is shorter than the predetermined reference time period of three minutes, the server generates a VoC item about the previous location, that is, the room. When the time period T1 that the customer stays at the current location, that is, the restaurant, is equal to or longer than the predetermined reference time period of three minutes, the server measures the time period T2 that the customer has stayed at the restaurant. When the time period T2 the customer has stayed at the restaurant is shorter than the predetermined reference time period of three minutes, the server generates a VoC item about the previous location, that is, the room.

However, when the time period T1 that the customer stays at the current location, that is, the restaurant, is equal to or longer than the predetermined reference time period of three minutes and the time period T2 the customer has stayed at the restaurant is equal to or longer than the predetermined reference time period of three minutes, the server generates a VoC item about the current location, that is, the restaurant.

That is, when the estimated time period that the customer will stay at the restaurant is shorter than three minutes, the server generates a VoC item about the previous location, that is, the room, and provides the VoC item to the customer. Further, even though the estimated time period that the customer will stay at the restaurant is equal to or longer than three minutes, before the lapse of three minutes from the time period that the customer visited the restaurant, the server may generate a VoC item about the previous location, that is, the room, and may provide the VoC item to the customer. After the lapse of three minutes from the time period that the customer visited the restaurant, the server may generate a VoC item about the restaurant and may provide the VoC item to the customer.

Table 3 shows an example of generating a VoC item in view of the time period T1 the customer stays at the current location. Particularly, Table 3 shows in detail a method for determining the number of VoC items to be provided to a customer, the length/depth of a question, and an answer method/level of a question by comparing the estimated time period T1 that the customer stays with each of preset reference time periods. The length/depth of a question and the answer method/level of a question are equivalent to those of a first-level VoC item and a second-level VoC item described above, and thus a detailed description thereof is omitted herein.

TABLE 3

| | Generation of VoC item | | | |
|---|---|---|---|---|
| T1 | | Question | Answer | |
| (minute) | Number | length/depth | method/level | Example |
| T1 ≤ 0.5 | 1 | Short question | Two answer | Was it easy to find the entrance to the |
| | | about overall | items | parking lot? (Yes/No) |
| | | state | | |
| 0.5 < T1 ≤ 3 | 1-2 | Question about | Three or | Were there any inconveniences during |
| | | specific | more answer | check-in at the front desk? (Very |
| | | situation | items | Satisfied/Satisfied/Average/Dissatisfied/Very |
| | | | | Dissatisfied) |
| | 3-5 | Short question | Two answer | Was the staff member at the front desk |
| | | about overall | items | friendly? (Yes/No) |
| | | state | | |
| 3 < T1 | 1-2 | Question about | Descriptive | How was the portion/the taste of the soybean |
| | | specific | answer | paste stew that you tried for the first time? |
| | | situation | | (Descriptive answer) |
| | 3-5 | | Three or | Did you have any problems using the |
| | | | more answer | elevator (Convenient/Average/Inconvenient) |
| | | | items | |
| | 6-10 | Short question | Two answer | Are you willing to visit our restaurant next |
| | | about overall | items | time? (Yes/No) |
| | | state | | |

Referring to Table 3, when the estimated time period T1 the customer stays at the current location is shorter than or equal to a predetermined first reference time period of 0.5 minutes, the server generates one VoC item including a short question about an overall state and two answer items. Assuming that the server generates a VoC item about the parking lot, the server may generate one first-level VoC item, for example, “Was it easy to find the entrance to the parking lot? (Yes/No)”.

When the estimated time period T1 the customer stays at the current location is longer than the predetermined first reference time period of 0.5 minutes and is shorter than or equal to a predetermined second reference time period of three minutes, the server generates one or two VoC items including a question about a specific situation and three or more answer items. Assuming that the server generates a VoC item about the front desk, the server may generate one or two second-level VoC items, for example, “Were there any inconveniences during check-in at the front desk? (Very Satisfied/Satisfied/Average/Dissatisfied/Very Dissatisfied)”.

Alternatively, when the estimated time period T1 the customer stays at the current location is longer than the predetermined first reference time period of 0.5 minutes and is shorter than or equal to the predetermined second reference time period of three minutes, the server generates three to five VoC items including a short question about an overall state and two answer items. Assuming that the server generates a VoC item about the front desk, the server may generate three to five first-level VoC items, for example, “Was the staff member at the front desk friendly? (Yes/No)”.

When the time period T1 the customer stays at the current location is longer than a predetermined second reference time period of three minutes, the server generates one or two VoC items including a question about a specific situation and a descriptive answer. Assuming that the server generates a VoC item about the restaurant, the server may generate one or two second-level VoC items, for example, “How was the portion/the taste of the soybean paste stew that you tried for the first time period? (Descriptive answer)”.

Alternatively, when the estimated time period T1 the customer stays at the current location is longer than a predetermined second reference time period of three minutes, the server generates three to five VoC items including a question about a specific situation and three or more answer items. Assuming that the server generates a VoC item about the elevator, the server may generate three to five second-level VoC items, for example, “Did you have any problems using the elevator (Convenient Average/Inconvenient)”.

When the time period T1 the customer stays at the current location is longer than a predetermined second reference time period of three minutes, the server generates six to ten VoC items including a short question about an overall state and two answer items. Assuming that the server generates a VoC item about the restaurant, the server may generate six to ten first-level VoC items, for example, “Are you willing to visit our restaurant next time? (Yes/No)”.

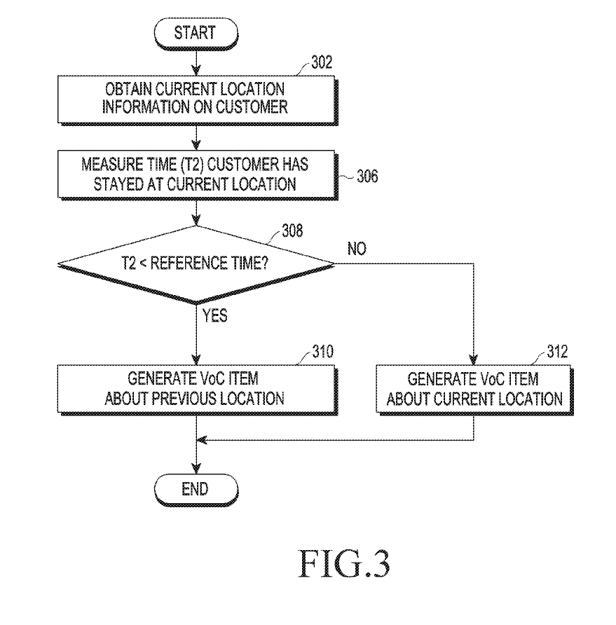

FIG. 3 is a flowchart illustrating an example in which a server generates a VoC item in view of the amount of time period that a customer has stayed at a current location according to an embodiment of the present disclosure.

Referring to FIG. 3, in operation 302, the server obtains current location information of the customer.

In operation 306, the server measures time period T2 the customer has stayed at a current location. In operation 308, the server checks whether the time period T2 the customer has stayed at the current location, measured in operation 306, is shorter than a predetermined reference time period for item generation. Here, it is assumed that the reference time period for item generation is, for example, one minute. When the time period T2 the customer has stayed at the current location is shorter than one minute in operation 308, the server generates a VoC item about a previous location, which is a location before a change, in operation 310. However, when the time period T2 the customer has stayed at the current location is equal to or longer than one minute in operation 308, the server generates a VoC item about the current location in operation 312.

Describing operations 310 and 312 with reference to the third moving path 106 of FIG. 1, the server measures the time period T2 the customer has stayed at the current location, that is, the restaurant. When the time period T2 the customer has stayed at the restaurant is shorter than the predetermined reference time period of one minute, the server generates a VoC item about the previous location, that is, the room. When the time period T2 the customer has stayed at the current location, that is, the restaurant, is equal to or longer than the predetermined reference time period of one minute, the server generates a VoC item about the current location, that is, the restaurant. That is, before the lapse of one minute from the time when the customer visited the restaurant, the server may generate a VoC item about the previous location, that is, the room, and may provide the VoC item to the customer. After the lapse of one minute from the time when the customer visited the restaurant, the server may generate a VoC item about the restaurant and may provide the VoC item to the customer.

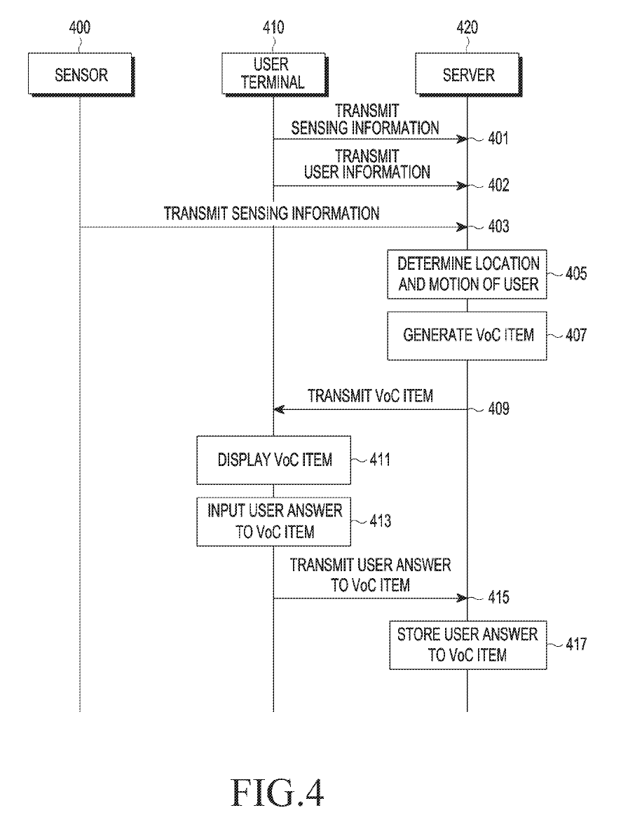

FIG. 4 illustrates a system that provides a VoC item generated based on a customer's moving path information according to an embodiment of the present disclosure.

Referring to FIG. 4, a sensor 400 may be mounted on hotel amenities, or may be installed on the ceiling or a wall, and includes a sensor for measuring the location of a customer and a sensor for measuring motion of the customer. The sensor measuring the location of the customer may include a sensor inside a room key, a motion sensor, a proximity sensor, and other communication device sensors, and the sensor for measuring the motion of the customer may include a motion sensor, a proximity sensor, and a Radio Frequency Identification (RFID) sensor. The motion of the customer may also be measured using camera (CCTV) image recognition.

A user terminal 410 may include a location measurement sensor and a motion measurement sensor. The location measurement sensor of the user terminal 410 may include an RFID sensor and a communication device sensor for a user terminal, and the motion measurement sensor of the user terminal 410 may include an accelerometer and a gyro sensor.

The user terminal 410 senses the location and/or motion of a customer and transmits sensing information to a server 420 (operation 401). The sensing information includes location information of the customer and/or moving information of the customer. The location of the customer may be measured using an RFID sensor of the user terminal 410 or a communication device sensor of the user terminal, and the motion of the customer may be measured using an accelerometer or a gyro sensor of the user terminal 410.

The user terminal 410 transmits the customer's information to the server 420 (operation 402). The user information includes, for example, information on a guest room where the related customer stays, information on at least one user terminal carried by the related customer, a hotel area/facility use history of the related customer relating to the previous visit to hotels, and a survey response history. The hotel area/facility use history and the survey response history may be information stored in the user terminal 410 or information stored in the server. When the hotel area/facility use history and the survey response history are stored in the server, the customer may transmit the user information to the server 420 and may receive the corresponding pieces of information from the server at check-in.

The sensor 400 senses the location and/or motion of a customer and transmits sensing information to a server 420 (operation 403). The sensing information includes location information of the customer and/or moving information of the customer. The location of the customer may be measured using a sensor inside a room key, a motion sensor, a proximity sensor, and other communication device sensors, and the motion of the customer may be measured using a motion sensor, a proximity sensor, or an RFID sensor.

Upon receiving the sensing information from the user terminal 410 and the sensor 400, the server 420 determines the location and motion of the customer (operation 405) and generates a VoC item in view of the estimated time period that the customer will stay at the current location and the time period that the customer has actually stayed at the current location (operation 407). A method for generating a VoC item has been described in detail with reference to FIGS. 2 and 3 and Table 2, and thus a detailed description thereof is omitted herein. Further, in the embodiment of the present disclosure, generating a VoC item includes selecting an appropriate VoC item from among VoC items stored in a database of the server in view of the estimated time period that the customer will stay at the current location and the time period that the customer has actually stayed at the current location.

The server transmits the VoC item generated in operation 407 to the user terminal 410 (operation 409), and the user terminal 410 receives and displays the VoC item (operation 411). Subsequently, when the customer inputs a user answer for the VoC item (operation 413), the user terminal 410 transmits the user answer for the VoC item to the server 420 (operation 415), and the server 420 receives and stores the user answer for the VoC item (operation 417).

For the convenience of description, FIG. 4 excludes the case where the customer is moving. However, when it is determined that the customer is moving in operation 405, that is, when the customer is currently moving, the server 420 determines that the customer is unable to answer and thus stops a subsequent operation. That is, the server 420 does not perform operations 407 to 417.

Alternatively, when it is determined that the customer is moving in operation 405, the server 420 generates a VoC item and does not perform the subsequent operations 409 to 417. Here, even though the customer is unable to answer, the server 420 generates the VoC item, which is for providing the generated VoC item to the user terminal 410 when the customer changes to a condition of being able to answer.

FIG. 4 illustrates an operation in which the server 420 generates a VoC item based on the sensing information received from each of the sensor 400 and the user terminal 410. However, in another example, the user terminal 410 may generate a VoC item using only the sensing information thereof without the assistance of the server 420, may display the generated VoC item, and may receive a user answer. That is, the user terminal may measure the location of the customer using an RFID sensor or a communication device sensor inside the terminal, may measure the motion of the customer using an accelerometer or a gyro sensor inside the terminal, and may generate a VoC item based on information on the measured location or information on the measured motion. Even when the user terminal 410 generates a VoC item using only the sensing information thereof without the assistance of the server 420, the user terminal 420 transmits a user answer for the VoC item to the server 420, and the server 420 receives and stores the user answer for the VoC item. The user answer for the VoC item stored in the server 420 is utilized later for the management of a user history.

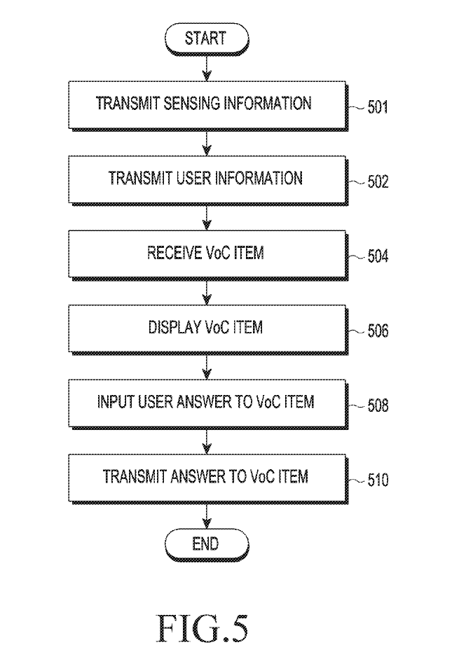

FIG. 5 is a flowchart illustrating an example in which a user answers a VoC item provided from a server via a user terminal according to an embodiment of the present disclosure.

Referring to FIG. 5, in operation 501, the user terminal transmits, to a server, sensing information including a customer's location information, measured using an RFID sensor or a communication device sensor inside the terminal, and moving information of the customer, measured using an accelerometer or a gyro sensor inside the terminal. In operation 502, the user terminal transmits the customer's information, for example, information on a guest room where the related customer stays, information on at least one user terminal carried by the related customer, a hotel area/facility use history of the related customer relating to the previous visit to a hotel, and a survey response history, to the server.

The user terminal receives a VoC item transmitted from the server in operation 504 and displays the received VoC item in operation 506.

When a user answer for the VoC item is input in operation 508, the user terminal transmits the user answer for the VoC item to the server in operation 510. FIG. 5 illustrates an operation in which the user terminal transmits the sensing information to the server and receives the VoC item generated from the server. However, in another example, the user terminal may directly generate a VoC item based on the sensing information, instead of transmitting the sensing information to the server.

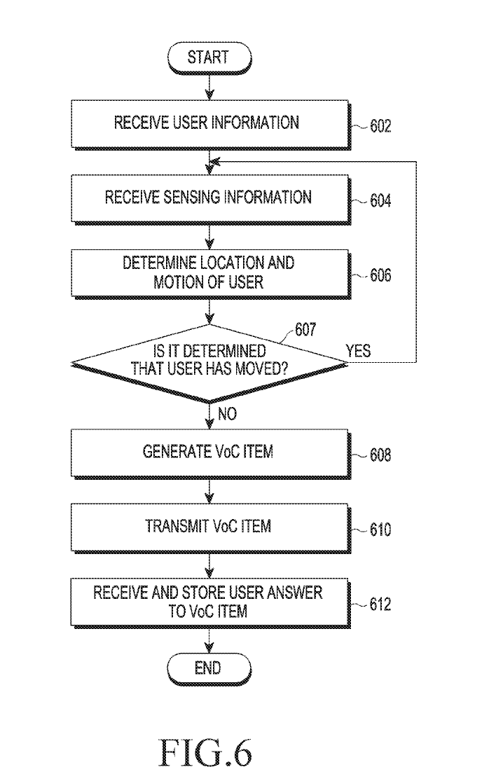

FIG. 6 is a flowchart illustrating an example in which a server provides a VoC item to a user terminal and receives an answer for the VoC item according to an embodiment of the present disclosure.

Referring to FIG. 6, in operation 602, the server receives a customer's information, for example, information on a guest room where the related customer stays, information on at least one user terminal carried by the related customer, a hotel area/facility use history of the related customer relating to the previous visit to a hotel, and a survey response history, from the user terminal.

In operation 604, the server receives sensing information transmitted from a sensor mounted on hotel amenities or installed on the ceiling or a wall and sensing information transmitted from the user terminal. Here, the sensor may include a sensor for measuring the location of a customer, for example, a sensor inside a room key, a motion sensor, a proximity sensor, and other communication device sensors, and a sensor for measuring motion of the customer, for example, a motion sensor, a proximity sensor, and an RFID sensor. Although it is illustrated that the motion of the customer is measured by a motion sensor, a proximity sensor, or an RFID sensor, the motion of the customer may also be measured using camera (CCTV) image recognition.

In operation 606, the server determines a user location and a user motion based on the user information received in operation 602 and the sensing information received in operation 604. In operation 607, the server checks whether it is determined that the user moves. When it is determined that the user does not move, the server generates a VoC item in operation 608. Here, the server generates the VoC item in view of the estimated time that period the customer will stay at the current location and the time period that the customer has actually stayed at the current location. The method for generating a VoC item has been described in detail with reference to FIGS. 2 and 3 and Table 3, and thus a detailed description thereof is omitted herein. Further, in the embodiment of the present disclosure, generating a VoC item includes selecting an appropriate VoC item from among VoC items stored in a database of the server in view of the estimated time period that the customer will stay at the current location and the time period that the customer has actually stayed at the current location.

When it is determined that the user has moved in operation 607, the server receives sensing information in operation 604.

In operation 610, the server transmits the VoC item generated in operation 608 to the user terminal. In operation 612, the server receives a user answer for the VoC item and stores the received user answer.

FIG. 6 illustrates an operation in which the server generates a VoC item and transmits the VoC item to the user terminal only when it is determined that the user does not move. However, the server may also generate a VoC item when it is determined that the user has moved. The server generates the VoC item even though the customer is moving in order to be able to provide the generated VoC item to the user terminal 410 when the customer changes to a condition of being able to answer.

In transmitting the VoC item to the user terminal, the server may determine whether to transmit the VoC item considering the importance of the VoC item. The importance of each VoC item is stored in advance in the server, and it is assumed that the importance is classified into, for example, “High”, “Medium”, and “Low”.

For example, assuming that the importance of a VoC item related to the cleanliness of a room is “High”, the importance of a VoC item related to hotel amenities is “Medium”, and the importance of a VoC item related to the food taste of a restaurant is “Low”, the VoC item related to the cleanliness of the room having the importance of “High” is provided to a user terminal carried by the customer, for example, a smartphone, a tablet PC, or a wearable device, and the customer is requested to directly input an answer for the VoC item. The VoC item related to the cleanliness of the room is an item having high importance and thus may be provided repeatedly. This VoC item may be provided to the user terminal separately before and after a request to clean the room due to the characteristics of service. When the VoC item of high importance is provided to the user terminal, the customer can answer later if unable to answer immediately. When there is a peripheral device that enables the customer to more easily answer the VoC item than the user terminal, for example, a device belonging to the hotel, even a VoC item of high importance may be provided to the peripheral device.

The VoC item related to the hotel amenities having second-highest importance following the importance of the cleanliness of the room may be provided to any device belonging to the hotel, and the customer may be requested to directly input an answer for the VoC item, or the customer's answer may be collected using an indirect method. An example of collecting customers' answers using an indirect method may be checking amenities used by the customer among amenities provided by the hotel, checking the time period to wait for the elevator, or checking the time period from entering the entrance to the parking lot to parking completion.

Further, regarding the VoC item related to the food taste of the restaurant, having the lowest importance, an answer for the VoC item may be collected using only surrounding sensing information, without providing the VoC item to the user. For example, assuming that a weight sensor is provided in each dish, it is possible to determine whether the customer has eaten all the food considering the weight of an empty dish and the weight of the dish after the customer finishes eating and accordingly to indirectly determine whether the customer is satisfied with the taste of the food. For example, when the weight of the dish after the customer finishes eating is closer to the weight of an empty dish, it may be determined that the customer's satisfaction with the taste of the food is higher.

Table 4 illustrates an answer request method and transmission status according to the importance of a VoC item.

TABLE 4

| | | Answer request | |
|---|---|---|---|
| VoC item | Importance | method | Transmission status |
| Cleanliness | High | Direct answer, | Transmitted to user |
| of room | | requested repeatedly | terminal |
| Hotel | Medium | Direct/indirect | Transmitted to device |
| amenities | | answer | belonging to hotel |
| Food taste of | Low | Indirect answer | Not transmitted |
| restaurant | | | |

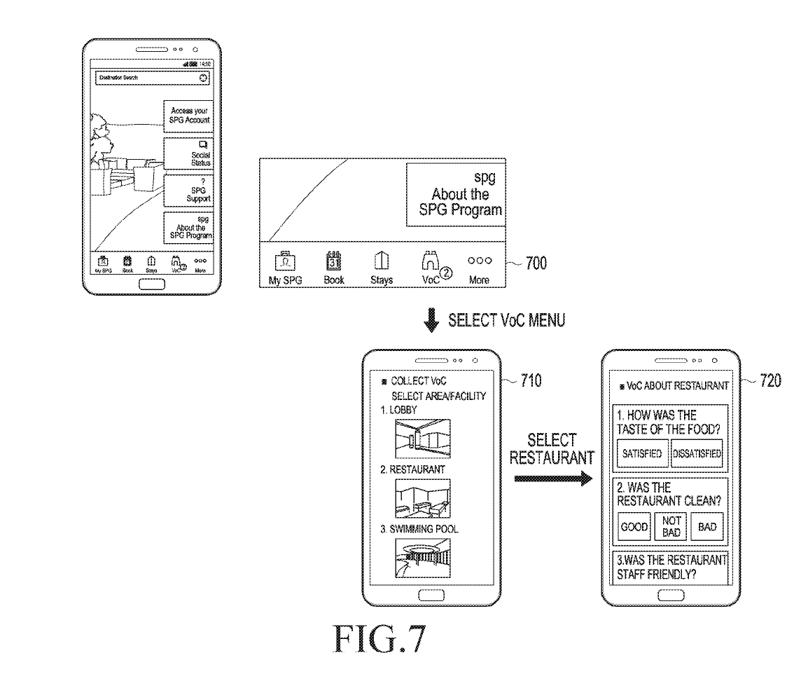

FIG. 7 illustrates an example of a user interface for a user terminal to generate and display a VoC item according to an embodiment of the present disclosure.

Referring to FIG. 7, a hotel application (app) is installed on a user terminal, and a customer's information, for example, information on a guest room where the customer stays, information on a user terminal carried by the customer, a hotel area/facility use history of the customer relating to the previous visit to hotels, and a survey response history, may be registered in a VoC item-providing server via the hotel application, or may be received from the server.

A customer visiting the hotel may click on a VoC icon displayed in a portion of the user terminal to select a VoC menu, and may input an answer to a provided VoC item. Here, the VoC icon displayed in the portion may display the number of unanswered VoC items in a previous stage, as shown on a screen 700. It is assumed that the number of unanswered VoC items in the previous stage is two on the screen 700.

When the customer clicks on the VoC icon to answer the VoC item, the user terminal displays a screen 710. That is, the user terminal displays an icon for each area/facility included in the customer's moving path information on the screen so that the customer may directly select an area/facility for a survey that the customer answers. In FIG. 7, it is assumed that areas/facilities included in the customer's the moving path information are a lobby, a restaurant, and a swimming pool.

Here, when the user clicks on a restaurant icon, the user terminal displays a VoC item related to the restaurant selected by the customer on a screen 720.

The customer may answer a VoC item “How was the taste of the food?” displayed on the screen by selecting “Satisfied” or “Dissatisfied”, and may answer the next VoC item “Was the restaurant clean?” by selecting “Good”, “Not Bad”, or “Bad”. The answers input by the user to the VoC items are transmitted to the server and are managed.

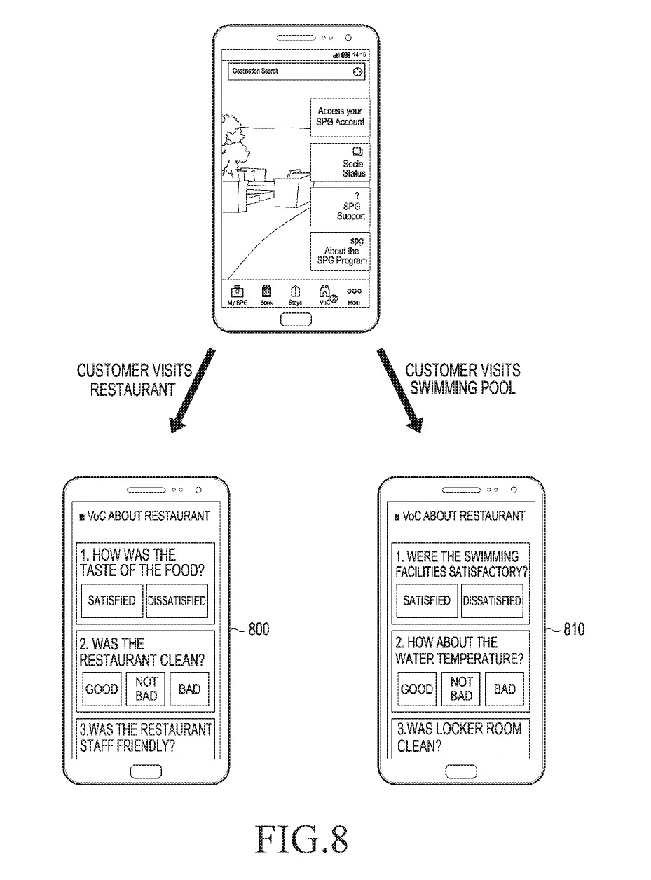

FIG. 8 illustrates another example of a user interface for a user terminal to generate and display a VoC item according to an embodiment of the present disclosure.

Referring to FIG. 8, a hotel application is installed on a user terminal, and a customer's information, for example, information on a guest room where the customer stays, information on a user terminal carried by the customer, a hotel area/facility use history of the customer relating to the previous visit to a hotel, and a survey response history, may be registered in a VoC item-providing server via the hotel application, or may be received from the server. Assuming that a customer visits a restaurant, the customer visiting the restaurant performs a tagging operation by transmitting tagging information to a tagging device installed in the restaurant, and receives current location information on the user terminal from the tagging device. Upon receiving the current location information, the user terminal determines the current location of the customer, generates a VoC item about the determined current location, and displays the VoC item to the customer. That is, the user terminal displays the VoC item about the current location, that is, the restaurant, on a screen 800. The customer may answer a VoC item “How was the taste of the food?” displayed on the screen by selecting “Satisfied” or “Dissatisfied”, and may answer the next VoC item “Was the restaurant clean?” by selecting “Good”, “Not Bad”, or “Bad”. The answers input by the user to the VoC items are transmitted to the server and are managed.

Here, when it is possible to identify, through the tagging information, the time at which the customer visits the restaurant, the time for which the customer is eating, the time at which the customer finishes eating, and the time at which the customer leaves the restaurant, the user terminal may generate an appropriate VoC item to be answered at each of the times and may display the generated VoC item to the customer at the corresponding time. For example, when it is determined through the tagging information that the customer is waiting to visit the restaurant, the user terminal may generate a VoC item including a survey on the situation before the visit to the restaurant and a survey on satisfaction with waiting status, and may display the VoC item to the customer. Here, the user terminal may utilize the history of the customer checking a menu provided from the restaurant before visiting the restaurant, the history of the customer checking a service provided by the restaurant, or the like when generating the VoC item.

In addition, when it is determined through the tagging information that the customer is currently waiting after ordering a food item on the menu, the user terminal may generate a VoC item including a survey on satisfaction with waiting time, a survey on satisfaction with staffs service, a survey on inconvenience due to a long wait, and a survey on the ambience or interior decoration of the restaurant, and may display the VoC item to the waiting customer. Here, the user terminal may utilize information on the food ordered by the customer when generating the VoC item.

Further, when it is determined through the tagging information that the customer is currently eating, the user terminal may generate a VoC item including the evaluation of equivalence between the ordered food and the actually served food, a survey on satisfaction with the portion/taste of the food, a survey on satisfaction with the composition (side dish) of the food, the evaluation of the portion/taste for the price, a survey on satisfaction with timing when a plurality of courses is served, the evaluation of a server, and the evaluation of satisfaction (immediate service) with an additional request, and may display the VoC item to the eating customer. Here, the user terminal may utilize the usage history of the customer in a visit to a previous restaurant and the current usage history when generating the VoC item.

In addition, when it is determined through the tagging information that the customer is currently paying the bill, the user terminal may generate a VoC item including a survey on overall satisfaction and may display the VoC item to the customer paying the bill.

Assuming that the customer visits a swimming pool, the customer visiting the swimming pool performs a tagging operation by transmitting tagging information to a tagging device installed in the swimming pool, and receives current location information on the user terminal from the tagging device. Upon receiving the current location information, the user terminal determines the current location of the customer, generates a VoC item about the determined current location, and displays the VoC item to the customer. That is, the user terminal displays the VoC item about the current location, that is, the swimming pool, on a screen 810. The customer may answer a VoC item “How satisfied are you with swimming facilities?” by selecting “Satisfied” or “Dissatisfied”, and may answer the next VoC item “How about the water temperature?” by selecting “Good”, “Not Bad”, or “Bad”. The answers input by the user to the VoC items are transmitted to the server and are managed.

Here, when it is possible to identify, through the tagging information, the time at which the customer visits the swimming pool and the time at which the customer leaves the swimming pool, the user terminal may generate an appropriate VoC item to be answered at each of the times, and may display the generated VoC item to the customer at the corresponding time.

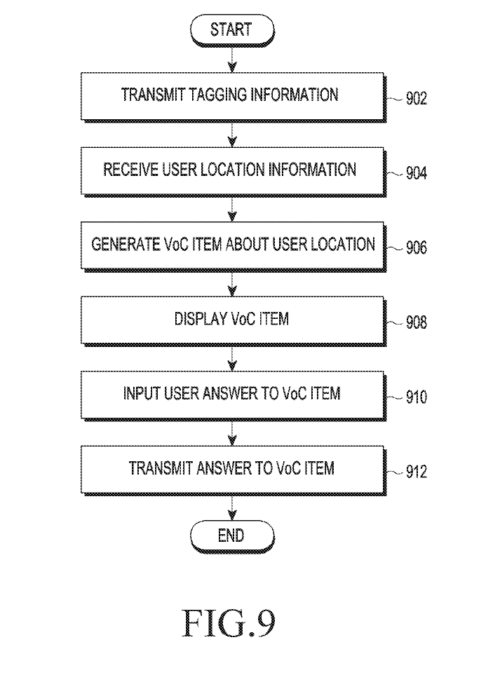

FIG. 9 is a flowchart illustrating an example in which a user terminal generates and displays a VoC item according to an embodiment of the present disclosure.

Referring to FIG. 9, in operation 902, the user terminal enters a specific area, transmits tagging information to a tagging terminal installed in the specific area, and performs a tagging operation. In operation 904, the user terminal receives user location information from the tagging device tagged by the user terminal.

In operation 907, the user terminal determines the current location of a user based on the user location information and generates a VoC item about the determined location of the user. In operation 908, the user terminal displays the generated VOC item to the user. When an answer for the VoC item is input from the user in operation 910, the user terminal transmits the input answer for the VoC item to the server in operation 912.

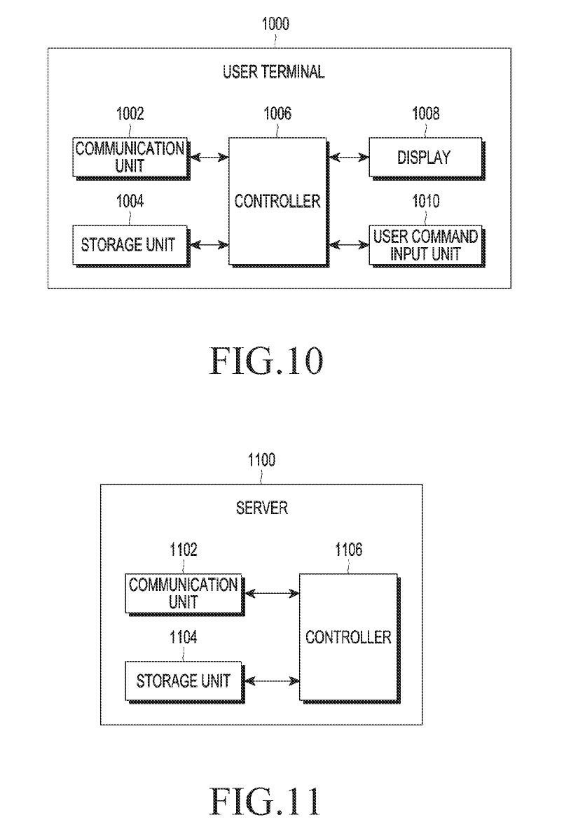

FIG. 10 illustrates the internal configuration of a user terminal that answers a VoC item provided from a server according to an embodiment of the present disclosure.

Referring to FIG. 10, the user terminal 1000 includes a communication unit 1002, a storage unit 1004, a controller 1006, a display 1008, and a user command input unit 1010.

The controller 1006 controls the overall operation of the user terminal 1000, and, in particular, performs an operation of generating a VoC item. In addition, the controller 1006 performs control to perform the overall operation related to a VoC item-providing operation according to an exemplary embodiment of the present disclosure. Here, the overall operation related to the VoC item-providing operation has been described with reference to FIGS. 1, 4, 5, and 7 to 9, and thus a detailed description thereof will be omitted here.

The communication unit 1002 transmits and receives various kinds of information necessary for communication with the server under the control of the controller 1006. In particular, the communication unit 1002 transmits information stored in the storage unit 1004 and receives a VoC item provided from the server. Here, various kinds of information transmitted and received by the communication unit 1002 have been described with reference to FIGS. 1, 4, 5, and 7 to 9, and thus a detailed description thereof will be omitted here.

The user command input unit 1010 receives commands input from a user, and, in particular, receives a user answer to a VoC item.

The storage unit 1004 stores all information on the user terminal 1000, particularly user information, such as information on a guest room where a customer stays, information on at least one user terminal carried by the related customer, a hotel area/facility use history of the related customer relating to the previous visit to hotels, and a survey response history.

The display 1008 displays a provided VoC item.

FIG. 11 illustrates the internal configuration of a server that provides a VoC item to a user terminal and receives an answer for the VoC item according to an embodiment of the present disclosure.

Referring to FIG. 11, the server 1100 includes a transmitter/a receiver 1102, and a controller 1106.

The controller 1106 controls the overall operation of the server 1100, and, in particular, performs an operation of generating a VoC item. In addition, the controller 1106 performs control to perform the overall operation related to a VoC item-providing operation according to an exemplary embodiment of the present disclosure. Here, the overall operation related to the VoC item-providing operation has been described with reference to FIGS. 1 to 3, 5, and 6, and thus a detailed description thereof will be omitted here.

The communication unit 1102 transmits and receives various kinds of information necessary for communication with a user terminal under the control of the controller 1106. In particular, the communication unit 1102 transmits information stored in a storage unit 1104 and transmits a VoC item to the user terminal. Here, various kinds of information transmitted and received by the communication unit 1102 have been described with reference to FIGS. 1 to 3, 5, and 6, and thus a detailed description thereof will be omitted here.

The storage unit 1104 stores all information on the server 1100, particularly user information received from the user terminal, such as information on a guest room where a customer stays, information on at least one user terminal carried by the related customer, a hotel area/facility use history of the related customer relating to the previous visit to a hotel, and a survey response history.

Although the embodiment has been described in the detailed description of the present disclosure, the present disclosure may be modified in various forms without departing from the scope of the present disclosure. Therefore, the scope of the present disclosure should not be defined as being limited to the embodiments, but should be defined by the appended claims and equivalents thereof.

1. A method for collecting a Voice of Customer (VoC) by a server, the method comprising:
receiving user information from a user terminal;
receiving sensing information related to a user;
generating a VoC item for surveying a service satisfaction with a particular location based on the user information and the sensing information; and
transmitting the generated VoC item to the user terminal and receiving a user answer for the VoC item from the user terminal.

2. The method of claim 1, further comprising:
determining an importance of the generated VoC item; and
determining, based on the importance, whether to transmit the generated VoC item to the user terminal, to transmit the generated VoC item to a peripheral device other than the user terminal, or not to transmit the generated VoC item,
wherein a VoC item of a relatively high importance is repeatedly transmitted to the user terminal, the user is requested to directly input an answer for the VoC item of the relatively high importance, and an answer to a VoC item of a relatively low importance is collected by an indirect method.

3. The method of claim 1, wherein the generating of the VoC item comprises:
measuring a current location based on sensing information related to a location of the user terminal;
obtaining a measured time period that a the user terminal stays at the current location or an estimated time period that the user terminal is expected to stay at the current location; and
selecting at least one VoC item from among preset VoC items based on the measured time or the estimated time period.

4. The method of claim 34, wherein the selecting at least one VoC item, comprises:
selecting at least one VoC item from among preset VoC items about a location previous to the current location when the measured time is shorter than a first reference time period or the estimated time period is shorter than a second reference time period; and
selecting at least one VoC item from among preset VoC items about the current location when the measured time period is equal to or longer than the first reference time period or the estimated time period is equal to or longer than the second reference time period.

5-6. (canceled)

7. The method of claim 1, further comprising:
determining whether the user terminal currently moves based on information on a motion of the user terminal comprised in the sensing information; and
determining whether to transmit the VoC item based on a determination result.

8. A method for collecting a Voice of Customer (VoC) by a user terminal, the method comprising:
transmitting user information and sensing information to a server;
receiving, from the server, a VoC item for surveying a service satisfaction with a particular location, which is generated based on the user information and the sensing information, and displaying the received VoC item; and
transmitting a user answer for the VoC item to the server when the user answer is input.

9. The method of claim 8, wherein the user information comprises at least one of information on a guest room where a customer stays, information on at least one user terminal carried by the related customer, a hotel area/facility use history of the related customer relating to a previous visit to a hotel, and a survey response history of the customer relating to a previous visit to a hotel.

10. A server for collecting a Voice of Customer (VoC) comprising:
a transceiver coupled to at least one processor;
the at least one processor configured to:
receive user information from a user terminal,
receive sensing information related to a location of the user terminal,
generate a VoC item for surveying a service satisfaction with a particular location based on the user information and the sensing information
transmit, to the user terminal, the generated VoC item, and to receive, from the user terminal, a user answer for the VoC item.

11. The server of claim 10, wherein the at least one processor is further configured to:
determine an importance of the generated VoC item, and
determine, based on the importance, whether to transmit the generated VoC item to the user terminal, to transmit the generated VoC item to a peripheral device other than the user terminal, or not to transmit the generated VoC item,
wherein a VoC item of a relatively high importance is repeatedly transmitted to the user terminal, the user is requested to directly input an answer for the VoC item of the relatively high importance, and an answer to a VoC item of a relatively low importance is collected by an indirect method.

12. The server of claim 10,
wherein the at least one processor is further configured to:
measure a current location based on sensing information related to a location of the user terminal,
obtain a measured time period that a the user terminal stays at the current location or an estimated time period that the user terminal is expected to stay at the current location; and
select at least one VoC item from among preset VoC items based on the measured time or the estimated time period.

13. The server of claim 1240,
wherein the at least one processor is further configured to:
selects at least one VoC item from among preset VoC items about a location previous to the current location when the measured time is shorter than a first reference time period or the estimated time period is shorter than a second reference time period; and
selecting at least one VoC item from among preset VoC items about the current location when the measured time period is equal to or longer than the first reference time period or the estimated time period is equal to or longer than the second reference time period.

14. (canceled)

15. A user terminal for collecting a Voice of Customer (VoC) comprising:
a transceiver coupled to at least one processor; and
the at least one processor configured to:
transmit, to a server, user information and sensing information,
receive, from the server, a VoC item for surveying a service satisfaction with a particular location, which is generated based on the user information and the sensing information, and to transmit a user answer for the VoC item,
display the received VoC item, and
transmit a user answer for the VoC item to the server when the user answer is input.

16. The user terminal of claim 15,
wherein the user information comprises at least one of information on a guest room where a customer stays, information on at least one user terminal carried by the related customer, a hotel area/facility use history of the related customer relating to a previous visit to a hotel, and a survey response history of the customer relating to a previous visit to a hotel.

17. The user terminal of claim 15,
wherein the at least one processor is further configured to:
measure a current location based on tagging information of the user terminal,
select a VoC item from among a plurality of VoC items stored in the user terminal for surveying a service satisfaction with the measured current location,
display the selected VoC item, and
transmit a user answer for the selected VoC item to the server when the user answer is input.

18. The user terminal of claim 17,
wherein the at least one processor is further configured to:
display a plurality of VoC icon corresponding respectively to a plurality of areas or facilities included in user's moving path information obtained based on the tagging information of the user terminal, and
display a VoC item corresponding to the VoC icon selected from the plurality of VoC icon;

19. The user terminal of claim 17,
wherein the at least one processor is further configured to:
display a number of at least one unanswered VoC item from among a plurality of VoC items, wherein the at least one unanswered VoC item is not input by the user.

20. The method of claim 8, further comprising:
measuring a current location based on tagging information of the user terminal;
selecting a VoC item from among a plurality of VoC items stored in the user terminal for surveying a service satisfaction with the measured current location;
displaying the selected VoC item; and
transmitting a user answer for the selected VoC item to the server when the user answer is input.

21. The method of claim 20, further comprising:
displaying a plurality of VoC icon corresponding respectively to a plurality of areas or facilities included in user's moving path information obtained based on the tagging information of the user terminal; and
displaying a VoC item corresponding to the VoC icon selected from the plurality of VoC icon;

22. The method of claim 20, further comprising:
displaying a number of at least one unanswered VoC item from among a plurality of VoC items, wherein the at least one unanswered VoC item is not input by the user.

23. The server of claim 10,
wherein the at least one processor is further configured to:
determine whether the user terminal currently moves based on information on a motion of the user terminal comprised in the sensing information; and
determine whether to transmit the VoC item based on a determination result.
